(19) United States
(12) Patent Application Publication
(10) Pub. No.: US 2015/0276692 A1
(43) Pub. Date: Oct. 1, 2015

(54) PROCESS FOR CONTROLLING AN IONIC LIQUID PROCESS AND REGENERATION USING A VISCOSITY MEASUREMENT

(71) Applicant: UOP LLC, Des Plaines, IL (US)

(72) Inventors: Paul Olson, Mount Prospect, IL (US); Douglas Andrew Nafis, Mount Prospect, IL (US); Michael Brendel, Chicago, IL (US)

(73) Assignee: UOP LLC, Des Plaines, IL (US)

(21) Appl. No.: 14/228,619

(22) Filed: Mar. 28, 2014

(51) Int. Cl. G01N 31/10; G01N 11/10

(52) U.S. Cl. CPC G01N 31/10; G01N 11/10

(57) ABSTRACT

A process in which the viscosity of an ionic liquid catalyst used in a continuous reaction is measured in order to determine the amount of conjunct polymer associated with the ionic liquid catalyst. The viscosity may be used to control: an amount of spent ionic liquid catalyst passed back to the reaction zone; an amount of spent ionic liquid catalyst passed to a regeneration zone; an amount of spent ionic liquid catalyst removed from the continuous reaction process; an amount of fresh ionic liquid catalyst passed to the reaction zone; an amount of regenerated ionic liquid catalyst passed to the reaction zone; or combinations thereof.

### BACKGROUND OF THE INVENTION

Acidic ionic liquid may be used as a catalyst in various chemical reactions, such as for the alkylation of isobutane with olefins. A by-product of this reaction is the accumulation, over time, of conjunct polymer in the liquid catalyst. As would be appreciated, conjunct polymer is typically highly olefinic, conjugated, highly cyclic hydrocarbons that form as a byproduct of various hydrocarbon conversion processes, including but not limited to alkylation, oligomerization, isomerization, and disproportionation.

Due to the olefinic and diolefinic functionality of conjunct polymer, it has a strong affinity for the acidic ionic liquid catalyst. This results in the catalyst losing acidity as the amount of conjunct polymer in ionic liquid catalyst increases. If acidity of the ionic liquid catalyst is reduced, the effectiveness of the catalyst in the reaction zone will be reduced as well.

Used (or spent) ionic liquid catalyst containing some conjunct polymer is typically recycled back into the reaction zone and a slip stream is typically diverted to a regeneration zone, in order to maintain a constant level of catalyst activity.

The ionic liquid catalyst can be regenerated by several processes. However, it still must be determined if the ionic liquid catalyst should be regenerated, or if the ionic liquid catalyst can be recycled back to the reaction zone.

Accordingly, it is known how to determine the amount of conjunct polymer in spent ionic liquid catalyst by various methods.

For example, U.S. Pat. Pub. No. 2012/0296145 discloses a process in which an amount of conjunct polymer in the ionic liquid phase is measured using infrared spectroscopy.

Additionally, U.S. Pat. Pub. No. 2010/0129921 discloses a process in which an amount of conjunct polymer in the ionic liquid phase is measured with an offline titration method.

It is also known how to determine the effectiveness of the ionic liquid catalyst based upon other factors.

For example, U.S. Pat. No. 8,142,725 discloses a method in which the amount of chloride in a hydrocarbon effluent stream is monitored and used as a basis to determine catalyst acidity. In this method, the amount of chloride is measured using conductivity.

These methods rely on a measurement process that takes time, a process that is run offline, a process that is susceptible to providing incorrect data based upon other variables, or a process that includes a combination of these drawbacks.

Therefore, it would be beneficial and desirable to have a process in which the amount of conjunct polymer in the ionic liquid is determined quickly in order to better control the used catalyst removal and regeneration rate.

### SUMMARY OF THE INVENTION

It has been discovered that viscosity of the ionic liquid can be used to determine the amount of conjunct polymer in the ionic liquid. Indeed, as the amount of conjunct polymer in the ionic liquid catalyst increases, the viscosity will increase. Therefore, measuring the viscosity will provide an indication of the amount of conjunct polymer in the ionic liquid catalyst.

One embodiment of the present invention is a process for monitoring an ionic liquid catalyst in a continuous reaction process in which an effluent from a reaction zone is separated into a light fraction and a heavy fraction, the heavy fraction comprising spent ionic liquid catalyst; a viscosity of the spent ionic liquid catalyst is measured; at least one of the following is controlled based upon the viscosity of the spent ionic liquid catalyst: an amount of spent ionic liquid catalyst passed back to the reaction zone; an amount of spent ionic liquid catalyst passed to a regeneration zone; an amount of regenerated ionic liquid catalyst passed to the reaction zone; an amount of fresh ionic liquid catalyst passed to the reaction zone; and, an amount of spent ionic liquid catalyst removed from the continuous reaction process.

It is contemplated that a reaction is performed in the presence of ionic liquid catalyst to form the effluent. The reaction is preferably performed in the reaction zone. The reaction may be a process selected from the group consisting of: alkylation; oligomerization, isomerization, and, disproportionation.

It is contemplated that all of the following parameters are controlled based upon the viscosity of the heavy fraction: the amount of spent ionic liquid catalyst passed back to the reaction zone; the amount of spent ionic liquid catalyst passed to a regeneration zone; the amount of regenerated ionic liquid catalyst passed to the reaction zone; the amount of fresh ionic liquid catalyst passed to the reaction zone; and, the amount of spent ionic liquid catalyst removed from the continuous reaction process.

The viscosity may be measured by an online measurement. Thus, it is contemplated that the viscosity of the spent fraction may be measured in a line which includes regenerated ionic liquid catalyst.

It is also contemplated to measure a temperature of the spent ionic liquid catalyst, and control at least one of the following based upon the viscosity of the spent ionic liquid catalyst and the temperature of the spent ionic liquid catalyst: the amount of spent ionic liquid catalyst passed back to the reaction zone; the amount of spent ionic liquid catalyst passed to the regeneration zone; the amount of regenerated ionic liquid catalyst passed to the reaction zone; the amount of fresh ionic liquid catalyst passed to the reaction zone; and, the amount of spent ionic liquid catalyst removed from the continuous reaction process.

The viscosity measurement of the spent ionic liquid catalyst may be repeated, and it may be repeated so long as the reaction is being performed.

It is further contemplated that a desired viscosity range of the spent ionic liquid catalyst is maintained.

At least a portion of the spent ionic liquid catalyst may be passed through a viscometer which measures the viscosity of the spent ionic liquid catalyst. The portion of the spent ionic liquid catalyst that has passed through the viscometer may be returned to the continuous process. The viscometer may be a coriolis meter, a rotating viscometer, a capillary viscometer, a vibrational viscometer, or, a microslit viscometer.

Another embodiment of the present invention provides a process for monitoring a catalyst in a continuous alkylation process in which an alkylation reaction is performed in the presence of an ionic liquid catalyst to form an effluent; the effluent is separated into a light fraction and a heavy fraction, the heavy fraction comprising spent ionic liquid catalyst; a viscosity of the spent ionic liquid catalyst is measured; a portion of the spent ionic liquid catalyst is returned to the alkylation reaction; and, a desired viscosity of the spent ionic liquid catalyst is maintained.

It is contemplated that the portion of the spent ionic liquid catalyst returned to the alkylation reaction is lowered if the viscosity of the spent ionic liquid catalyst is above the desired viscosity range. A fresh ionic liquid catalyst, a regenerated ionic liquid catalyst, or both may be also passed to the alkylation reaction if the viscosity of the spent ionic liquid catalyst is above the desired viscosity range.

It is also contemplated that the viscosity is measured online.

It is further contemplated to determine an amount of conjunct polymer in the spent ionic liquid catalyst by performing an offline test. The test may be a titration of the heavy fraction, a weight or volume measurement of conjunct polymer isolated from the heavy fraction, infrared spectroscopy of the heavy fraction, gas chromatography of a conjunct polymer isolated from the heavy fraction, nuclear magnetic resonance of the heavy fraction, and combinations thereof.

It is contemplated that a portion of the spent ionic liquid catalyst is passed to a regeneration zone to provide a regenerated ionic liquid catalyst.

At least a portion of the spent ionic liquid catalyst may be passed through a viscometer which measures the viscosity of the spent ionic liquid catalyst. The portion of the spent ionic liquid catalyst that has passed through the viscometer may also be passed back to the continuous alkylation process.

Additional embodiments and details of the invention are set forth in the following detailed description of the invention.

### DETAILED DESCRIPTION OF THE DRAWING

In the drawings:

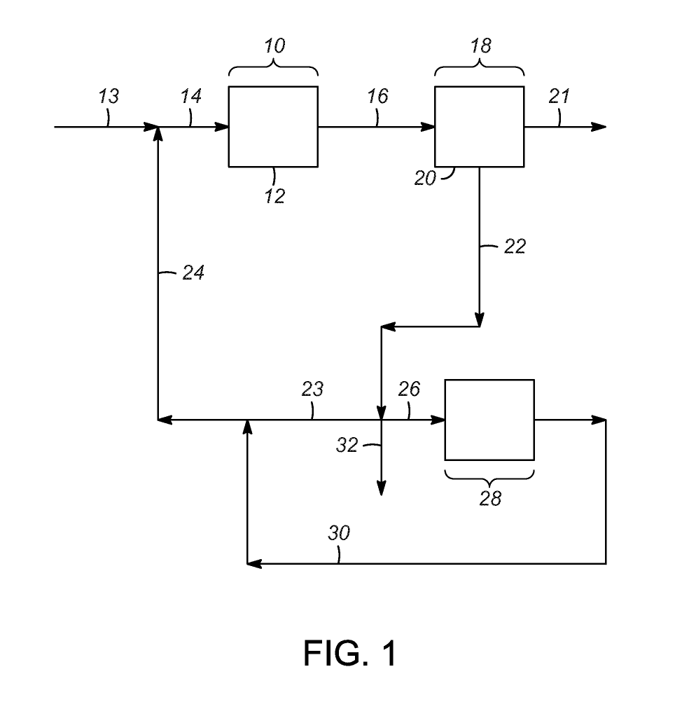

FIG. 1 shows a process for monitoring a spent ionic liquid catalyst according to one or more embodiments of the present invention; and,

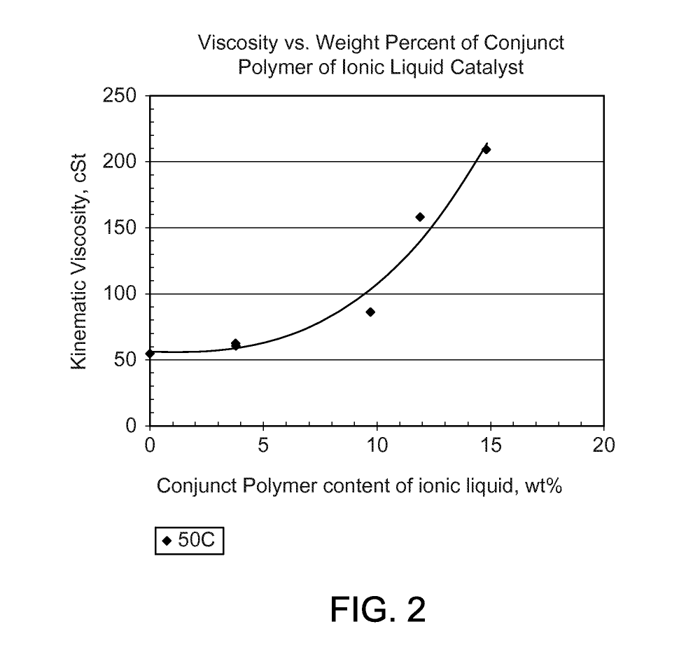

FIG. 2 shows a graph showing a correlation of the viscosity of spent ionic liquid catalyst and the amount of conjunct polymer associated with same.

### DETAILED DESCRIPTION OF THE INVENTION

A process has been discovered in which the viscosity of a spent ionic liquid catalyst is measured in order to determine the amount of conjunct polymer associated with same.

As used herein, “fresh ionic liquid catalyst” is used to refer to ionic liquid catalyst that has not been used as a catalyst in any reaction process. As used herein, “regenerated ionic liquid catalyst” is used to refer to ionic liquid catalyst which is removed from a regeneration zone. Finally, as used herein, “spent ionic liquid catalyst” is used to refer to ionic liquid catalyst removed from a reaction zone that includes conjunct polymer and which has not been passed to a regeneration zone and which may include regenerated ionic liquid catalyst that has been reused in the reaction process as a catalyst.

Therefore, with reference to FIG. 1, a process according to one or more embodiments of the present invention relates to a continuous reaction of compounds introduced into a reaction zone 10, preferably having a vessel 12.

It is contemplated that the reaction is a hydrocarbon conversion reaction, and in a preferred embodiment, the reaction is a continuous alkylation process. In a continuous alkylation process, an iso-paraffin, such as isobutane, is contacted with the ionic liquid catalyst in a mixing zone, resulting in an ionic liquid/hydrocarbon emulsion. Olefins such as butenes are fed into the emulsion and react to form alkylated products, primarily trimethylpentanes and other iso-octanes if the paraffin contains four carbons and the olefin contains four carbons. The emulsion is then separated into a heavy portion containing spent ionic liquid catalyst and a light portion containing the iso-paraffin and products. The separation may occur by gravity, by coalescing, by both, or by otherwise recovering the droplets of spent ionic liquid catalyst.

In a most preferred embodiment of the present invention, the reaction is a continuous alkylation of isobutane with olefins to form predominately trimethylpentanes and other iso-octanes. However, it will be appreciated that the present invention is not limited to only the preferred reaction and that other reactions, including oligomerization, isomerization, and disproportionation reactions can be utilized with the various embodiments of the present invention.

Returning to FIG. 1, also introduced into the reaction zone 10 via a line 14 is a catalyst for the reaction. The catalyst is an ionic liquid catalyst. Since the process may be a continuous process, at the start of the process, or at other times based upon other parameters and in order to maintain the same amount of ionic liquid catalyst in the process, fresh ionic liquid catalyst may introduced via a line 13.

An effluent is passed via a line 16 from the reaction zone 10 to a separation zone 18. The separation zone 18 preferably includes at least one vessel 20. Although not shown, it is contemplated that more than one vessel 20 is present in the separation zone 18. Each vessel 20 may be empty or, alternatively it may have equipment.

In the vessel 20 of the separation zone 18, the effluent may separate into a light fraction and a heavy fraction based upon differences in the densities of the components. Again, this separation may occur as a result of the different densities or by other means such as coalescing ionic liquid droplets. The light fraction comprises the desired product from the reaction, and may also comprise various other byproducts of the reaction. The heavy fraction comprises spent ionic liquid catalyst.

The light fraction may be removed from the separation zone 18 via a line 21 and processed, stored, or both. The details of the product recovery are not necessary for one of ordinary skill in the art to understand or practice the present invention.

The spent ionic liquid catalyst is returned to the reaction zone 10, for example, via lines 22, 23, 24. As shown, the spent ionic liquid catalyst can be combined with fresh ionic liquid catalyst in line 13 and returned via line 14 to the reaction zone 10. At least a portion of the spent ionic liquid catalyst may also be passed via a line 26 to a regeneration zone 28. As will be discussed in more detail below, in the regeneration zone 28, at least some of the conjunct polymer may be removed from the spent ionic liquid catalyst to provide a regenerated ionic liquid catalyst. The regenerated catalyst may be passed via a line 30 back to the reaction zone 10.

As shown in FIG. 1, regenerated ionic liquid catalyst is passed into the line 23 passing spent ionic liquid catalyst back to the reaction zone 10. Finally, it is also contemplated that spent ionic liquid catalyst is removed from the process, for example, via a drag stream 32. As will be appreciated, the depicted configuration is a simplified and exemplary design and is not intended to be limiting.

As long as the level of conjunct polymer in the spent ionic liquid catalyst is low enough that the effectiveness of the ionic liquid catalyst is not greatly negatively impacted, the spent ionic liquid catalyst may be returned back to the reaction zone 10 and reused as ionic liquid catalyst in the reaction zone 10. The present invention is directed to determining the amount of conjunct polymer in the spent ionic liquid catalyst by measuring the viscosity of the spent ionic liquid catalyst.

Accordingly, a viscosity of the spent ionic liquid catalyst is measured, preferably with a viscometer. The viscometer is preferably disposed online, meaning that the viscometer is either disposed (i.e., located) within a line through which the spent ionic liquid catalyst passes or is in a position to directly measure the viscosity in the vessel 20 in which the spent ionic liquid is a separate phase. Accordingly, the viscometer may be disposed within any of the lines 22, 23, 24 used to pass spent ionic liquid catalyst back to the reaction zone 10. The viscometer may be disposed in the line 26 used to pass spent ionic liquid catalyst to the regeneration zone 26 or in the drag stream 32 for removing spent ionic liquid catalyst from the process. The viscometer may be used in the line 30 passing regenerated ionic liquid catalyst back to the reaction zone 10. Additionally, it is contemplated, that the viscometer is disposed so that it measures the viscosity of the spent ionic liquid catalyst at the bottom of the vessel 20 in the separation zone 18.

It is contemplated that the viscometer is a coriolis meter, a rotating viscometer, a capillary viscometer, a vibrational viscometer, or a microslit viscometer. Other viscometers may also be used. It is also contemplated that more than one viscometer is used and that viscometers are located in different places throughout the process.

It is contemplated to include a bypass line to allow the ionic liquid catalyst (fresh, spent, or regenerated) to flow around the viscometer in cases where the viscosity does not need to be measured, to avoid flow restrictions based upon the viscometer, or for other reasons that will be apparent to one of ordinary skill in the art. Other configurations can be utilized.

It is also contemplated that one viscometer is used for example to measure viscosity of the spent ionic liquid catalyst and another viscometer is used to measure the viscosity of the regenerated ionic liquid catalyst to ensure that the regeneration process is achieving the desired level of removal of conjunct polymer.

For example, when the viscosity is too high, indicating a high level of conjunct polymer, a first portion of the spent ionic liquid may be returned back to the reaction zone 10, while at the same time a second portion of the spent ionic liquid catalyst is passed to the regeneration zone 28. Once the viscosity returns to a desired level, the valve can change the flow of the spent ionic liquid catalyst accordingly so that more of the spent ionic liquid catalyst is recycled back to the reaction zone 10 and less is passed to the regeneration zone 28, or, all of the spent ionic liquid catalyst is returned back to the reaction zone 10.

In some embodiments of the present invention, at least one of the following amounts is controlled based upon the viscosity of the spent ionic liquid catalyst: an amount of spent ionic liquid catalyst passed back to the reaction zone 10; an amount of spent ionic liquid catalyst passed to the regeneration zone 28; an amount of the regenerated ionic liquid catalyst passed to the reaction zone 10; an amount of fresh ionic liquid catalyst passed to the reaction zone 10; and an amount of spent ionic liquid catalyst removed from the process. It is preferred that more than one is controlled, and most preferred that all of these are controlled based upon the viscosity and used to maintain a desired viscosity level. The control can be continuous or at specific intervals.

A valve may be used to direct the flow of the spent ionic liquid catalyst. For example, the valve may direct the flow of the spent ionic liquid catalyst through line 23 to return to the reaction zone 10. Additionally and alternatively, the valve may direct the flow of the spent ionic liquid catalyst through the line 26 to the regeneration zone 28. The valve can comprise a three-way valve, or comprise multiple valves, control valves, capillaries and tubes, or any other configuration which would obtain the same result as a multi-way valve.

This direction of flow from the valve may be a complete split, meaning the entire spent ionic liquid catalyst is passed either to the reaction zone 10 or to the regeneration zone 28. Alternatively, the valve may also split the flow of the spent ionic liquid catalyst fraction so that the spent ionic liquid catalyst to send to both the reaction zone 10 and the regeneration zone 28 at the same time. Additionally, these amounts may vary based upon processes conditions. In this manner, the flow of the spent ionic liquid catalyst through the valve may be controlled based upon the viscosity of the spent ionic liquid catalyst and used to maintain a desired viscosity level for the spent ionic liquid catalyst.

It is contemplated that the valve is automatically controlled based upon viscosity and control parameters, such as temperature. Accordingly, the valve (or multiple control valves) is preferably in communication with viscometer via a computer, which controls operation of valve(s) based upon the viscosity of the spent ionic liquid catalyst measured by the viscometer, as well as the temperature of the spent ionic liquid catalyst.

Additionally, it is further contemplated to measure the temperature of all of the spent ionic liquid catalyst streams because their viscosities will change based upon the temperature. Thus, the process may be controlled based upon a combination of the measured viscosity and temperature.

Furthermore, since the viscosity of each individual system may differ slightly, it is contemplated that a calibration curve be developed in which an offline test also measures the amount of conjunct polymer. The offline test may be a titration of the spent ionic liquid catalyst, infrared spectroscopy of the spent ionic liquid catalyst, gas chromatography of a conjunct polymer isolated from the spent ionic liquid catalyst, nuclear magnetic resonance of the spent ionic liquid catalyst, and, combinations thereof. Additionally, it is further contemplated that an amount of conjunct polymer is determined by extracting or separating the conjunct polymer and determining the weight or volume of the insolated conjunct polymer relative to the sample of the spent ionic liquid catalyst.

Once one or more calibration curves have been established, the viscosity parameters of the process may be used to control the flow of the spent ionic liquid catalyst, maintain a desired viscosity or both. Moreover, based upon the above, it is contemplated that various calibration curves are established based upon the temperature of the spent ionic liquid catalyst. The calibration curve(s) may be used to determine the levels at which the amount of conjunct polymer in the spent ionic liquid catalyst is unacceptable.

As an example, various samples of spent ionic liquid catalyst were taken from a continuous pilot plant operation at conditions selected to provide different levels of deactivation of the ionic liquid catalyst. The viscosity of each sample (at 50° C.) was measured. Additionally, the viscosity of a fresh ionic liquid sample was also measured and recorded.

Additionally, the weight percent of the conjunct polymer in each spent ionic liquid sample was determined with an offline analysis using hydrolysis. Specifically, approximately 1.500 g of spent ionic liquid catalyst was weighed into a glass vial. The exact weight of the vial and cap was recorded.

A stir bar was then added to the vial and the container was recapped. The vial was placed in an ice bath sitting over a stir plate. Slowly, 6 cc of ice water was added to the stirring, cooled spent ionic liquid catalyst samples. HCl was evolved. Then, 10 cc of hexanes were added to the hydrolyzed spent ionic liquid catalyst.

Stirring continued for approximately 30 seconds before allowing the two phases to separate. The hydrocarbon phase was transferred to a container via a pipette.

The spent ionic liquid catalyst phase was extracted 2 more times with 10 cc of hexanes. If the 3rd extract still seemed colored, washings were continued with 10 cc aliquots of hexanes until the extract appeared colorless. After combining all of the organic phases and drying over MgSO₄, this liquid was transferred after syringe filtration into a tared round bottom flask. Following hexanes removal under reduced pressure, the round bottom flask was reweighed and the weight percent of conjunct polymer isolated was calculated based on how much spent ionic liquid catalyst was hydrolyzed.

The results of the viscosity and conjunct polymer (“CP”) weight percent measurements are shown below in TABLE 1 and in FIG. 2.

TABLE 1

| Sample | wt % CP | cSt@50 C. |
|---|---|---|
| 1 | 14.82 | 209.30 |
| 2 | 11.90 | 157.90 |
| 3 | 9.71 | 86.33 |
| 4 | 3.78 | 62.45 |
| 5 | 3.78 | 60.89 |
| Fresh IL | 0.00 | 54.7 |

As can be seen, for example in FIG. 2, the results show that viscosity can be measured and used to monitor activity of the spent ionic liquid catalyst based upon the amount of conjunct polymer associated with spent ionic liquid catalyst. Such a curve can be used to establish a desired viscosity level or range.

The viscosity may be constantly measured so long as the reaction is being performed, i.e., continuously. Alternatively, the viscosity could be measured every minute, every ten minutes, or other me interval. The measurement could also be done with a combination of the two.

Returning to FIG. 1, in the regeneration zone 28, the ionic liquid catalyst reacts with one or more compounds to remove at least a portion of the conjunct polymer from the ionic liquid catalyst.

A variety of methods for regenerating ionic liquids have been developed. The ionic liquid containing the conjunct polymer could be contacted with a reducing metal (e.g., Al), an inert hydrocarbon (e.g., hexane), and hydrogen and heated to about 100° C. The conjunct polymer will be transferred to the hydrocarbon phase, allowing for the conjunct polymer to be removed from the ionic liquid phase. See e.g., U.S. Pat. No. 7,651,970; U.S. Pat. No. 7,825,055; U.S. Pat. No. 7,956,002; and U.S. Pat. No. 7,732,363.

Another method involves contacting the ionic liquid containing the conjunct polymer with a reducing metal (e.g., Al) in the presence of an inert hydrocarbon (e.g. hexane), but in the absence of added hydrogen, and heating to about 100° C. The conjunct polymer will be transferred to the hydrocarbon phase, allowing for the conjunct polymer to be removed from the ionic liquid phase. See e.g., U.S. Pat. No. 7,674,739.

Still another method of regenerating the ionic liquid involves contacting the ionic liquid containing the conjunct polymer with a reducing metal (e.g., Al), HO, and an inert hydrocarbon (e.g. hexane), and heating to about 100° C. The conjunct polymer will be transferred to the hydrocarbon phase, allowing for the conjunct polymer to be removed from the ionic liquid phase. See e.g., U.S. Pat. No. 7,727,925.

The ionic liquid can be regenerated by adding a homogeneous metal hydrogenation catalyst (e.g., (PPh₃)₃RhCl) to the ionic liquid containing the conjunct polymer and an inert hydrocarbon (e.g. hexane). Hydrogen would be introduced, and the conjunct polymer would be reduced and transferred to the hydrocarbon layer. See e.g., U.S. Pat. No. 7,678,727.

Another method for regenerating the ionic liquid involves adding HCl, isobutane, and an inert hydrocarbon to the ionic liquid containing the conjunct polymer and heating to about 100° C. The conjunct polymer would react to form an uncharged complex, which would transfer to the hydrocarbon phase. See e.g., U.S. Pat. No. 7,674,740.

The ionic liquid could also be regenerated by adding a supported metal hydrogenation catalyst (e.g. Pd/C) to the ionic liquid containing the conjunct polymer and an inert hydrocarbon (e.g. hexane). Hydrogen would be introduced and the conjunct polymer would be reduced and transferred to the hydrocarbon layer. See e.g., U.S. Pat. No. 7,691,771.

Still another method involves adding a basic reagent that displaces the conjunct polymer and is a part of the regeneration of the catalyst. The basic reagents are described as nitrogen-containing compounds such as amines, pyridinium compounds, or pyrrolidinium compounds. For example, a suitable substrate (e.g. pyridine) is added to the ionic liquid containing the conjunct polymer. After a period of time, an inert hydrocarbon would be added to wash away the liberated conjunct polymer. The ionic liquid precursor [1-butyl-1-methylpyrrolidinium][Cl] would be added to the ionic liquid (e.g. [1-butyl-1-methylpyrrolidinium][Al₇Cl₇]) containing the conjunct polymer followed by an inert hydrocarbon. After a given time of mixing, the hydrocarbon layer would be separated, resulting in a regenerated ionic liquid. The solid residue would be converted to ionic liquid by adding AlCl₃. See e.g., U.S. Pat. No. 7,737,067.

Another method involves adding the ionic liquid containing the conjunct polymer to a suitable substrate (e.g. pyridine) and an electrochemical cell containing two aluminum electrodes and an inert hydrocarbon. A voltage would be applied and the current measured to determine the extent of reduction. After a given time, the inert hydrocarbon would be separated, resulting in a regenerated ionic liquid. See, e.g., U.S. Pat. No. 8,524,623.

It is also contemplated that the viscosity of the regenerated ionic liquid catalyst is measured, for example, to determine if the regeneration zone 28 is functioning efficiently, at what rate the reaction is occurring, relative amounts of deactivating contaminants in the system, or what amount of the catalyst is being permanently deactivated, or for other reasons that would be appreciated by those of ordinary skill in the art.

As mentioned above, it is contemplated to introduce fresh ionic liquid catalyst into the reaction zone 10 as well as remove spent ionic liquid catalyst from the process. This could be, for example, if the viscosity does not return to the desired level after adjustment, or if the spent ionic liquid catalyst has become contaminated, or merely to maintain the proper amount of ionic liquid catalyst in the process.

One or more embodiments of the present invention provide a process that minimizes the amount of ionic liquid catalyst wasted with destructive testing.

Furthermore, one or more embodiments of the present invention provide a process that can be adjusted to measure the viscosity continuously, at intervals, or both so as to provide current conditions of the ionic liquid catalyst.

Moreover, one or more embodiments of the present invention provide a process that allows for selective control, automation of the regeneration of the ionic liquid catalyst, a process the maintains an effective level of ionic liquid catalyst by measuring and maintaining a viscosity of spent ionic liquid catalyst, or a combination thereof.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

What is claimed is:

1. A process for monitoring an ionic liquid catalyst in a continuous reaction process comprising:
separating an effluent from a reaction zone into a light fraction and a heavy fraction, the heavy fraction comprising spent ionic liquid catalyst;
measuring a viscosity of the spent ionic liquid catalyst;
controlling at least one of the following based upon the viscosity of the spent ionic liquid catalyst:
an amount of spent ionic liquid catalyst passed back to the reaction zone;
an amount of spent ionic liquid catalyst passed to a regeneration zone;
an amount of regenerated ionic liquid catalyst passed to the reaction zone;
an amount of fresh ionic liquid catalyst passed to the reaction zone; and,
an amount of spent ionic liquid catalyst removed from the continuous reaction process.

2. The process of claim 1 further comprising:
performing a reaction in the presence of ionic liquid catalyst to form the effluent, wherein the reaction is performed in the reaction zone.

3. The process of claim 2 wherein the reaction is a process selected from the group consisting of: alkylation; oligomerization; isomerization; and, disproportionation.

4. The process of claim 1 wherein all of the following are controlled based upon the viscosity of the heavy fraction:
the amount of spent ionic liquid catalyst passed back to the reaction zone;
the amount of spent ionic liquid catalyst passed to a regeneration zone;
the amount of regenerated ionic liquid catalyst passed to the reaction zone;
the amount of fresh ionic liquid catalyst passed to the reaction zone; and,
the amount of spent ionic liquid catalyst removed from the continuous reaction process.

5. The process of claim 1 wherein measuring the viscosity comprises an online measurement.

6. The process of claim 1 further comprising:
measuring a temperature of the spent ionic liquid catalyst; and,
controlling at least one of the following based upon the viscosity of the spent ionic liquid catalyst and the temperature of the spent ionic liquid catalyst:
the amount of spent ionic liquid catalyst passed back to the reaction zone;
the amount of spent ionic liquid catalyst passed to a regeneration zone;
the amount of regenerated ionic liquid catalyst passed to the reaction zone;
the amount of fresh ionic liquid catalyst passed to the reaction zone; and,
the amount of spent ionic liquid catalyst removed from the continuous reaction process.

7. The process of claim 1 wherein measuring the viscosity of the spent ionic liquid catalyst is repeated.

8. The process of claim 1 further comprising:
maintaining a desired viscosity range of the spent ionic liquid catalyst.

9. The process of claim 1 further comprising:
passing at least a portion of the spent ionic liquid catalyst through a viscometer which measures the viscosity of the spent ionic liquid catalyst.

10. The process of claim 9 further comprising:
returning the portion of the spent ionic liquid catalyst that has passed through the viscometer back to the continuous process.

11. The process of claim 9 wherein the viscometer comprises at least one of: a coriolis meter; a rotating viscometer; a capillary viscometer; a vibrational viscometer; or, a microslit viscometer.

12. The process of claim 1 further comprising:
repeating measuring of the viscosity of the spent ionic liquid catalyst so long as the reaction is being performed.

13. The process of claim 1 wherein the viscosity of the spent fraction is measured in a line which includes regenerated ionic liquid catalyst.

14. A process for monitoring a catalyst in a continuous alkylation process comprising:
performing an alkylation reaction in the presence of an ionic liquid catalyst to form an effluent;
separating the effluent into a light fraction and a heavy fraction, the heavy fraction comprising spent ionic liquid catalyst;
measuring a viscosity of the spent ionic liquid catalyst;
returning a portion of the spent ionic liquid catalyst to alkylation reaction; and,
maintaining a desired viscosity range of the spent ionic liquid catalyst.

15. The process of claim 14 further comprising:
lowering the portion of the spent ionic liquid catalyst returned to the alkylation reaction if the viscosity of the spent ionic liquid catalyst is above the desired viscosity range.

16. The process of claim 15 further comprising:
passing a fresh ionic liquid catalyst, a regenerated ionic liquid catalyst, or both to the alkylation reaction if the viscosity of the spent ionic liquid catalyst is above the desired viscosity range.

17. The process of claim 14 wherein the viscosity is measured online.

18. The process of claim 17 further comprising:
determining an amount of conjunct polymer in the spent ionic liquid catalyst by performing an offline test selected from the group consisting of: a titration of the heavy fraction; a weight or volume measurement of conjunct polymer isolated from the heavy fraction; infrared spectroscopy of the heavy fraction; gas chromatography of a conjunct polymer isolated from the heavy fraction; nuclear magnetic resonance of the heavy fraction; and combinations thereof.

19. The process of claim 14 further comprising:
passing a portion of the spent ionic liquid catalyst to a regeneration zone to provide a regenerated ionic liquid catalyst.

20. The process of claim 14 further comprising:
passing at least a portion of the spent ionic liquid catalyst through a viscometer which measures the viscosity of the spent ionic liquid catalyst; and,
returning the portion of the spent ionic liquid catalyst that has passed through the viscometer back to the continuous alkylation process.
